(19) United States
(12) Patent Application Publication
(10) Pub. No.: US 2026/0160859 A1
(43) Pub. Date: Jun. 11, 2026

(54) Operating method of a detection radar following two Doppler sub-modes and associated detection radar

(71) Applicant: THALES, Meudon (FR)

(72) Inventors: Philippe GOY, MERIGNAC (FR); Rodolphe COTTRON, MERIGNAC (FR); Stéphane KEMKEMIAN, MERIGNAC (FR)

(21) Appl. No.: 19/411,692

(22) Filed: Dec. 8, 2025

(30) Foreign Application Priority Data
Dec. 10, 2024 (FR) FR2413761

(51) Int. Cl. G01S 7/292; G01S 7/02; G01S 7/41; G01S 13/524; G01S 13/89

(52) U.S. Cl. CPC G01S 7/2927; G01S 7/024; G01S 7/414; G01S 13/5242; G01S 13/89

(57) ABSTRACT

An operating method for a radar includes a signal emission/receipt step including the following sub-steps: generation of two consecutive pulses associated with a first and a second Doppler sub-mode; emission of pulses in different frequency bands; receipt of pulse echoes in a common time window; preprocessing of received echoes in relation to the first Doppler sub-mode to determine a clutter zone; and preprocessing of received echoes in relation to the second Doppler sub-mode outside the clutter zone. The method further includes the step of implementation of an extraction processing from a preprocessing result of received echoes in relation to the second Doppler sub-mode.

### FIELD OF THE INVENTION

The present invention relates to an operating method of a detection radar following at least two Doppler sub-modes.

The present invention also relates to a detection radar implementing such a method.

The technical field of the invention is that of radar systems embedded onboard aircraft, ships, submarines or satellites, for example, implementing target detection/identification.

The general problem solved by the invention is managing the presence of ground and sea clutter that disrupts the operation of detectors traditionally used in radar, based on a power map analysis.

### BACKGROUND OF THE INVENTION

As known per se, the radar modes for detecting aerial and ground mobile targets use Doppler waveforms. The phase coherence between pulses enables exploiting the Doppler effect linked to the relative movement of targets vis-à-vis the radar. This classic technique enables separating targets based on their radial velocity. It has significantly increased the radar's discriminating power vis-à-vis fixed clutter (usually from the ground) or slightly mobile clutter (usually from the sea).

Doppler processing is a coherent processing (exploiting phase information) that enables increasing the coherent gain vis-à-vis Gaussian white noise and, for a given target, its signal-to-noise ratio (SNR).

Doppler processing enables carving up the echoes spread out, such as ground and sea clutter, on the frequency axis. The resolution cell of the Doppler processing, also called a bin, is inversely proportional to the integration time. The average surface equivalent radar (SER) of a surface clutter on a distance-velocity cell is then proportional to the Doppler resolution cell.

In general, the repetition frequencies Fr are chosen depending on the velocity ranges to be processed due to the fact that the ambiguous velocity depends on the wavelength λ and on the Fr.

$${V}_{amb} = λ Fr / 2.$$

The target detection is then performed on two-dimensional power maps (distance, velocity). A contrast between the test cell and the ambient noise is made, then thresholding, to decide if a detection is present in the test bin.

To combat clutter zones in the context of detecting aerial and ground targets, a solution can be to disable the detection function over the entire velocity domain (or Doppler frequency) of the ground clutter, i.e. in the velocity domain (or Doppler frequency) where the ground clutter is located. This avoids detecting the main echoes. This technique is commonly called “Doppler notch”: a minimum detection velocity is imposed, ensuring that this velocity is higher than the trace of the ground (or sea) clutter.

A disadvantage of this solution is that it does not enable any detection in the velocity domain corresponding to ground clutter, causing a notch in the detected velocity axis. It also does not manage secondary clutter zones. The main reason is that the notch width is not adaptive.

To eliminate secondary clutter echoes, an antenna processing can be performed, by using an ancillary or interferometry channel to suppress any detection from secondary lobes, for example. This technique thus consists of tracking all primary detections at the power map level and then filtering a posteriori via antenna processing. This technique has two constraints: the use of multiple receipt channels, on the one hand, and zones close to the clutter remain desensitized depending on the detector topology chosen, on the other hand.

Another known solution consists of a technique of projection a priori of clutter zones on power maps from carrier information and an antenna beam model. The zones thus defined on the power maps are filtered at the detector level, to avoid any detection in these zones. This technique is an evolved and adaptive version of the Doppler notch and adapts particularly to secondary clutter zones.

A similar technique can be used to project clutter zones in the unambiguous domain (distance, velocity). Any detection after extraction falling into these zones can be eliminated (or, conditionally, to a suppression SER).

An image processing on power maps (Da, Va) can also be used to recognize clutter zones. These processes, although effective, have two drawbacks: they can be heavy in terms of computational load and can include targets close to the clutter (primary or secondary) in the clutter zones to be suppressed.

The known solutions are therefore not sufficiently effective in terms of clutter zone detection or require a significant computational load. Moreover, without a priori knowledge of the sea clutter velocity, the aforementioned techniques do not enable effectively managing the Doppler notch (adaptive or not) in the presence of sea clutter.

### SUMMARY OF THE INVENTION

The present invention aims to solve this problem of the prior art and propose means to determine clutter zones effectively, without excessive computational load.

In particular, the invention enables recognizing clutter zones upstream of detection techniques, so as to help them resolve target detection on power maps filtered of primary and secondary clutter.

Moreover, one of the advantages of the invention is that it works regardless of the configuration and type of surface clutter (sea velocity, mixing between ground and sea clutter, etc.).

To this end, the invention relates to a method for operating a target detection radar following a Doppler mode, the method comprising the implementation of several recurrences of a signal emission/receipt step, with each n^{th} recurrence of said step comprising the following sub-steps:
generation of two consecutive pulses associated with a first Doppler sub-mode and a second Doppler sub-mode, said Doppler sub-modes defining different energy balances;
emission of pulses in different frequency bands according to different emission directions;
receipt of pulse echoes in a common time window;
preprocessing of received echoes in relation to the first Doppler sub-mode to determine at least one clutter zone;
preprocessing of received echoes in relation to the second Doppler sub-mode outside the or each clutter zone determined in relation to the first Doppler sub-mode;
the method further comprising the following step:
implementation of an extraction processing from a result of preprocessing received echoes in relation to the second Doppler sub-mode.

According to other advantageous aspects of the invention, the method comprises one or more of the following features, taken individually or in any technically possible combination:
the second Doppler sub-mode defines a greater energy balance than the first Doppler sub-mode;
the pulse associated with the second Doppler sub-mode has a greater width than the pulse associated with the first Doppler sub-mode;
the detection radar is embedded in an aircraft;
the emission direction of the pulse associated with the first Doppler sub-mode corresponds to the ground/sea direction;
the step of preprocessing received echoes in relation to the first Doppler sub-mode comprises the determination of at least one primary clutter zone and/or at least one secondary clutter zone;
each of the sub-steps of preprocessing received echoes comprises the determination of a power map of echoes, defining a distance axis and a velocity axis;
the or each clutter zone is determined by thresholding the power map determined in relation to the first Doppler sub-mode;
the or each clutter zone determined in relation to the first Doppler sub-mode is transferred in the form of a mask on the power map determined in relation to the second Doppler sub-mode;
the mask is determined by a constant noise value;
the step of preprocessing echoes in relation to the second Doppler sub-mode defines a first detection path and a second detection path, the first detection path being implemented from an unmasked power map and the second detection path being implemented from a masked power map;
said preprocessing step further comprising a fusion of detections from the two detection paths;
during the emission sub-step, the corresponding pulses are emitted using different chirp slopes used to emit them or by adding a random phase;
during the receipt sub-step, echoes associated with different pulses are distinguished by determining the slopes of the corresponding chirps or the corresponding phase;
during the emission sub-step, the corresponding pulses are emitted using different polarizations;
during the receipt sub-step, echoes associated with different pulses are distinguished by determining their polarizations;
a polarization is emitted for each pulse, or a set of polarizations forming a signature is emitted for each pulse.

The invention also relates to a target detection radar comprising technical means configured to implement the method as defined above.

### BRIEF DESCRIPTION OF THE DRAWINGS

The invention will appear more clearly upon reading the following description, given solely by way of non-limiting example, and made with reference to the drawings, wherein:

FIG. 1 is a schematic view of a detection radar according to the invention,

FIG. 2 is a flowchart of a radar operating method of FIG. 1, and

FIGS. 3 to 5 are different views illustrating the implementation of the method of FIG. 2.

### DETAILED DESCRIPTION OF THE INVENTION

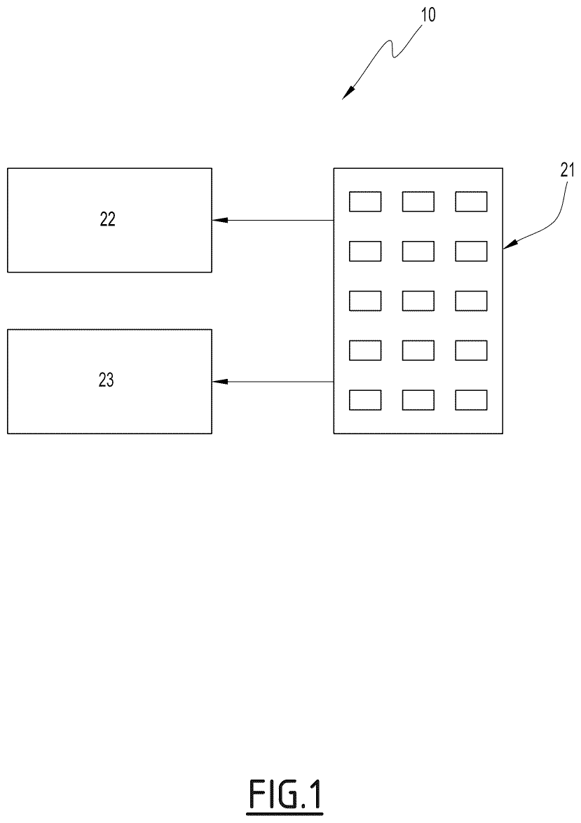

FIG. 1 illustrates a detection radar 10 according to the invention. This radar 10 is intended to be embedded on a mobile carrier moving in the air and/or on a terrestrial surface and/or on a maritime surface, for example. Advantageously, the radar 10 is intended to be embedded on a carrier moving in the air, such as an aircraft. In a variant, the radar 10 is arranged in a fixed manner.

The radar 10 enables detecting targets, following a Doppler mode of the MMTI type (“Maritime Moving Target Indicator”), GMTI (“Ground Moving Target Indicator”), or AMTI (“Aerial Moving Targets”), for example.

With reference to FIG. 1, the radar 10 comprises an array of elementary antennas 21 enabling the emission of signals in the form of pulses and the receipt of signals corresponding to echoes of these pulses.

The radar 10 further comprises an emission unit 22, enabling the generation of pulses to be emitted by the antenna array 21, and a receipt unit 23, enabling the processing of echoes received by the antenna array 21 so as to deduce the presence of a target and, possibly, a velocity and a distance to this target.

Each of the units 22, 23 is made in the form of a programmable circuit of the FPGA type (“Field Programmable Gate Array”) and/or of the ASIC type (“Application-Specific Integrated Circuit”), for example. In addition, or in a variant, each of these units 22, 23 is made at least partially in the form of software executable by a processor and stored in a memory.

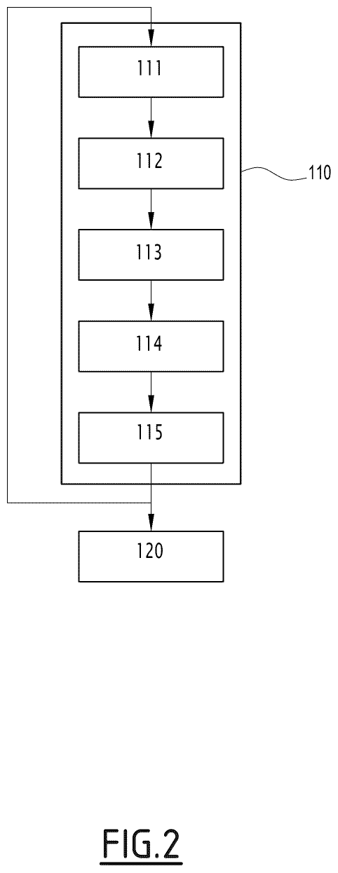

The operating method of the radar 10 will now be explained with reference to FIG. 2 presenting a flowchart of its steps.

This method is considered implemented during an electronic scan and/or a mechanical scan (in azimuth and/or elevation, for example) of the space around the radar 10, by implementing conventional beam forming upon emission and receipt, for example. In particular, this method comprises the iterative implementation of at least step 110 described below for each pointing position of the radar 10. Each iteration of this step is called a recurrence.

The pointing positions are further considered to succeed each other according to a predetermined rotation direction and they all define an angular opening dependent on the pointing angle known to the person skilled in the art. All the pointing positions define a visibility cone available from the radar 10. In other words, “visibility cone” means all the different pointing positions during a scan around performed by the radar 10. Without loss of generality, the sequence of these pointing positions can also be random, to perform a complete scan of the visibility cone.

Each n^{th} recurrence of step 110 comprises a signal emission/receipt in the corresponding pointing position.

In particular, during this step, the emission unit 22 of the radar 10 emits signals that have a particular waveform, and the receipt unit 23 receives echoes of these signals.

The signals emitted/received during this step are of the so-called communalized wave type.

Each communalized wave comprises at least two consecutive pulses associated with different energy balances. Thus, each pulse defines a Doppler sub-mode, namely a first Doppler sub-mode and a second Doppler sub-mode, with an associated spatial domain, as will be explained later. The different Doppler sub-modes use the same set of waveforms and, in particular, the same repetition period and the same emitted bandwidth. Moreover, advantageously, the pulses are emitted according to emission directions so that the associated spatial domains extend in different directions.

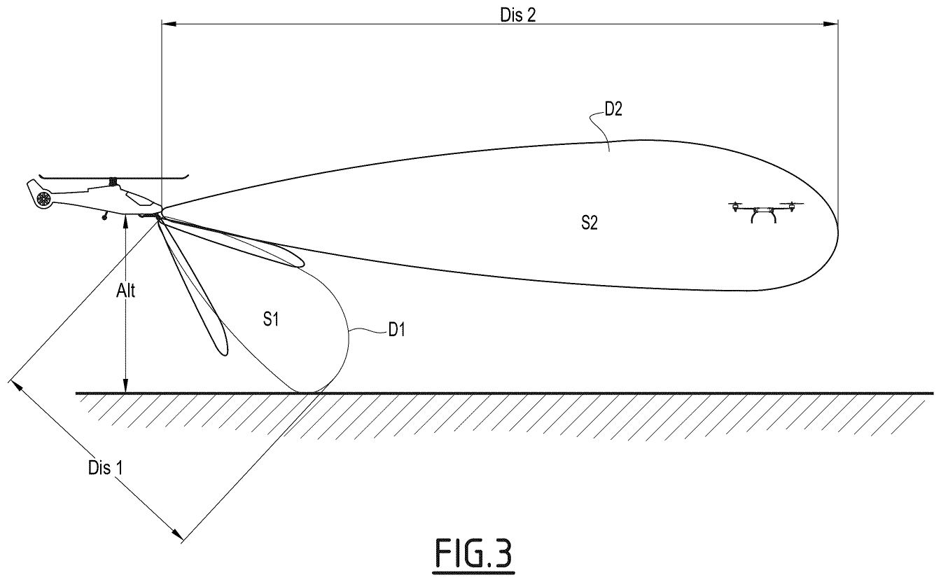

FIG. 3 illustrates an example of a Doppler mode of the AIR type, for example, broken down into a first sub-mode S1, defining a spatial domain D1, and a second sub-mode S2, defining a spatial domain D2. The sub-mode S2 has a stronger energy balance than the sub-mode S1. Furthermore, according to the first sub-mode S1, the corresponding pulses are emitted towards the ground/sea. Thus, the first spatial domain D1 extends in a direction oriented towards the ground/sea. According to the second sub-mode S2, the corresponding pulses are emitted in the direction of the carrier's movement. Thus, the second spatial domain D2 extends in this direction, substantially parallel to the ground/sea. The two domains D1, D2 define overlap zones, corresponding in particular to the secondary lobes of the antennas during the emission of the corresponding pulses. In particular, according to one embodiment example, the secondary lobes of the sub-mode S1 also point in the main direction of the sub-mode S2, and vice versa.

In general, each spatial domain can be defined by an emission direction and, in some cases, by a distance to the radar 10. The emission direction can be defined by a pair of angular values, for example. These angular values correspond to the elevation (or site) and to the azimuth of emission, denoted by El and Az, respectively, for example.

In the example of FIG. 3, the domain D2 can be defined by a distance Dis2 to the radar 10 and an elevation angle equal to 0°, for example. This domain corresponds to the volume where an aerial target is to be detected during the current pointing. In the same example, the domain D1 corresponds to the analysis volume of surface clutter (ground and/or sea). The ambiguous distance domain processed by the two sub-modes is given by the characteristics of the common waveform, i.e.

$$D min = c * Te / 2 and D max = c * ( Tr - Te / 2 )$$

where:
Te is the duration of an emission window;
Tr is the duration of a receipt window;
c is the velocity of sound.

Moreover, in practice, Dis2>Dis1>Dmax>Dmin.

The step 110, of signal emission/receipt, comprises several sub-steps that will be explained in detail below.

During the sub-step 111, the emission unit 22 of the radar 10 generates two consecutive pulses associated with different Doppler sub-modes, i.e. with different energy balances.

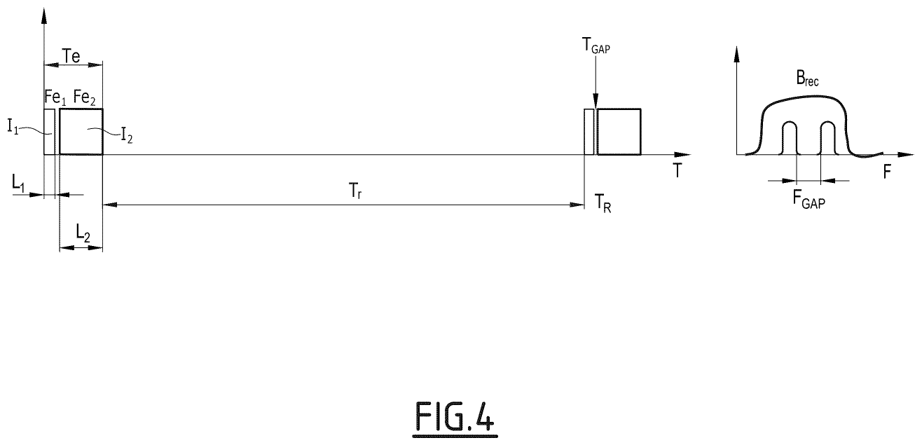

Thus, during the sub-step 111, the emission unit 22 generates a first pulse I₁ related to the first Doppler sub-mode (sub-mode S1 in the example of FIG. 3) and a second pulse I₂ related to the second sub-mode (sub-mode S2 in the example of FIG. 3). These two pulses are illustrated in FIG. 4.

The pulses I₁ and I₂ are associated with the same repetition frequency, different emission directions and different emission frequencies. The emission direction is defined by a pair of previously defined angular values, for example.

The pulses I₁ and I₂ are generated in an emission window Te wherein each pulse has a width Li and is spaced from the other pulse and from one of the boundaries of the emission window Te by a time gap T_{GAP}. This time gap T_{GAP} is chosen as small as possible, depending on the transmitter's capabilities. In all that follows, the index i=1 designates any value relative to the first pulse, and i=2 designates any value relative to the second pulse.

The energy balance of each pulse is defined by its width Li. Thus, to have different energy balances, the width Li of one of the pulses is strictly greater than the width Li of the other. In one particular mode, the width Li of one of the pulses is at least twice as large as that of the other. Thus, according to one example, 5% of the emission window Te can be allocated to one of the sub-modes, and 95% of the emission window Te can be allocated to the other sub-mode. This represents a difference in energy balance of about 13 dB. For example, in the case of a 1%/99% ratio, the difference in energy balance is 20 dB.

In the example of FIG. 4, the width L₂ of the pulse associated with the second sub-mode (i.e. pulse I₂) is strictly greater than the width L₁ of the pulse associated with the first sub-mode (i.e. pulse I₁). Thus, in this example, the second sub-mode presents a greater energy balance than the first sub-mode. Conversely, the first pulse I₁ can have a greater width than the second pulse I₂.

In the frequency domain, the pulses share the same frequency support Brec, with a frequency gap F_{GAP} between the carrier frequencies Fi corresponding to the frequency bands Bi of these pulses. The frequency gap F_{GAP} is chosen as being sufficient to distinguish the echoes of these pulses upon receipt. In all that follows, a frequency band is defined by a central frequency and a bandwidth. Advantageously, in the following, all frequency bands have the same width. Moreover, the frequency gap F_{GAP} is measured between a pair of corresponding central frequencies and is greater than the width of each frequency band.

The frequency bands B₁ and B₂ of the first pulse I₁ and the second pulse I₂, respectively, are advantageously chosen as the same for each recurrence of step 110. Thus, the same central frequency Fe₁ and the same central frequency Fe₂ are chosen for the first pulse and for the second pulse, respectively, in each recurrence of step 110, ensuring phase coherence between recurrences to proceed with Doppler processing. Moreover, advantageously and alternatively, the shortest pulse can be made without linear frequency modulation (LFM) so that its temporal width is compatible with the desired distance resolution, without pulse compression (since it is without LFM), i.e. L₁=1/B₂.

During the sub-step 112, the emission unit 22 emits the pulses generated during the previous sub-step in the corresponding frequency bands.

During the sub-step 113, the receipt unit 23 receives echoes corresponding to the emitted pulses in a common receipt time window. The duration Tr of this common receipt window is equal to the total duration of the recurrence T_{R} (i.e. the observation time of the corresponding pointing for a recurrence, as previously defined) minus the duration of the emission window Te. During receipt, echoes corresponding to different pulses are distinguished by the different frequency bands, using band-pass filters around the central frequencies, for example.

During the sub-step 114, the receipt unit 23 performs preprocessing of received echoes in relation to the first Doppler sub-mode.

This preprocessing comprises the implementation of at least some techniques chosen from a pulse compression technique, a clutter rejection technique and a Doppler processing technique. These techniques specifically enable establishing a power map of echoes depending on the velocity and distance to the radar 10. In other words, such a power map is defined by a distance axis and a velocity axis. It should be noted that implementing the clutter rejection technique enables not saturating the receivers on nearby clutter. Even after rejection, the clutter remains sufficiently powerful in relation to the thermal noise floor.

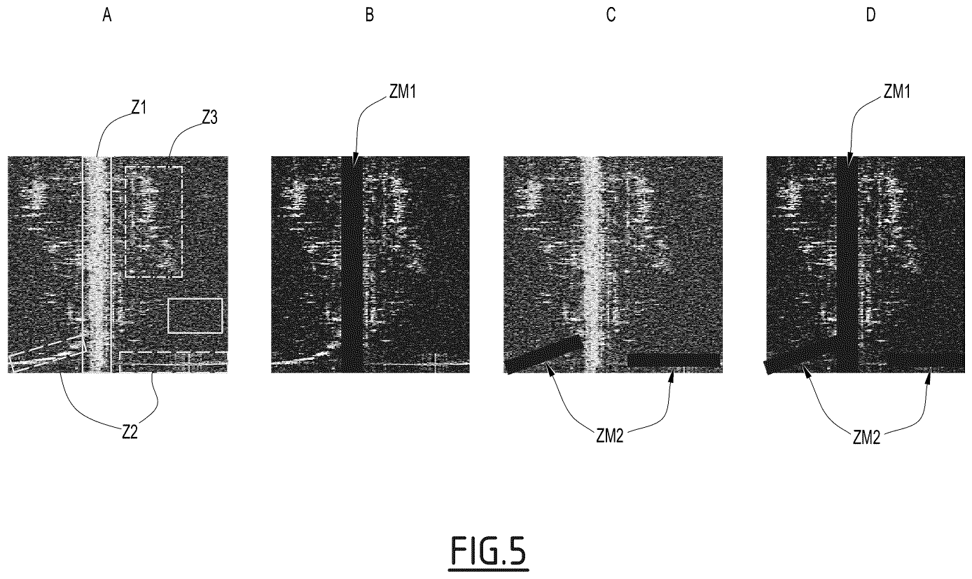

An example of such a map is shown in part A of FIG. 5. According to this example, the power map defines a primary clutter zone Z1 corresponding to the main lobe of the antennas, two secondary clutter zones Z2 corresponding to the secondary lobes of the antennas, and a target zone Z3 comprising targets.

Advantageously, during the sub-step 114, the receipt unit 23 further implements a technique for suppressing at least secondary clutter zones Z2. This technique may specifically comprise thresholding.

For this, the suppression technique consists of first identifying the background of the power map corresponding to the average thermal noise power Pbth. Then, knowing the geometry, the energy balance and a ground clutter type SER (or reflectivity), the technique can deduce a clutter-to-noise ratio (CNR) that corresponds to the clutter power of a resolution cell divided by Pbth. The clutter must be excluded when the CNR is at least above the detection threshold, i.e. class 10-15 dB (without post-integration). The technique then applies a threshold on the power map of the first sub-mode equal to the threshold of the second sub-mode plus a detection margin plus another margin (3-5 dB or more) to capture clutter zones, for example. Useful targets will not benefit from the antenna gain and therefore do not stand out on the first sub-mode. This will enable recovering secondary clutter zones (those targeted by the first sub-mode antenna) but also, in some cases, the primary clutter (which will be seen by the secondary lobes of the first analysis sub-mode).

Each determined secondary clutter zone Z2 can then be replaced by a constant value corresponding to an average thermal noise level, for example, as illustrated in part C of FIG. 5 where the zones ZM2 replace the secondary clutter zones Z2.

According to some embodiments, during the sub-step 114, the receipt unit 23 further implements a technique for suppressing the primary clutter zone. To do so, thresholding can also be applied. In particular, thresholding can be performed from the (sufficiently strong) average thermal noise level to determine the velocity position and width of the primary clutter zone Z1. Then, as in the previous case, the primary clutter zone can be replaced by an average thermal noise level. This is illustrated in part B of FIG. 5 where zone ZM1 replaces the primary clutter zone Z1.

Finally, all the clutter zones (primary and secondary) can be replaced by an average thermal noise level, as illustrated in part D of FIG. 5.

During the sub-step 115, the receipt unit 23 performs preprocessing of received echoes in relation to the second Doppler sub-mode. This sub-step can be implemented at least partially in parallel with the sub-step 114.

As in the previous case, this preprocessing comprises the implementation of at least some techniques chosen from a pulse compression technique, a clutter rejection technique and a Doppler processing technique. Also as in the previous case, these techniques specifically enable establishing a power map of echoes depending on the velocity and distance to the radar 10, in relation to the second Doppler sub-mode.

Moreover, during this sub-step 115, the receipt unit 23 implements an ambient noise measurement technique and a detection technique, of the CFAR (“constant false alarm rate”) type, for example.

Moreover, advantageously during this sub-step 115, the receipt unit 23 implements a masking technique for each clutter zone determined during sub-step 114 on the power map determined in relation to the second Doppler sub-mode.

This masking technique is advantageously implemented before the detection technique (during the implementation of the clutter rejection technique, for example) and comprises the masking of each clutter zone determined in relation to the first Doppler sub-mode, on the power map determined in relation to the second Doppler sub-mode. For this purpose, each clutter zone determined during the sub-step 114 can be presented in the form of a mask defined by a constant noise value. This mask can then be applied to the power map determined in relation to the second Doppler sub-mode. This power map is hereafter called the masked power map. The detection technique is then implemented on this masked power map.

According to another embodiment example, the detection technique is implemented according to two detection paths. In such a case, a first detection path can be implemented on an unmasked power map (i.e. a power map as initially determined) and a second detection path can be implemented on the masked power map. Then, a result of such detection can comprise a fusion of results from the two paths.

According to both examples, the detection technique specifically enables pre-detecting targets that must be confirmed during an extraction processing that will be explained in detail later. Thus, this technique enables generating a list of pre-detections, i.e. a list of pre-detected targets, by analyzing the masked power map or both maps, namely the masked map and the unmasked map.

During a subsequent step 120, the receipt unit 23 performs an extraction processing from the list of pre-detections determined during step 110.

In particular, and in a manner known per se, such extraction processing takes advantage of the information gleaned by using several repetition periods (or repetition frequency Fr) made within the same pointing so as to resolve the distance/velocity ambiguities by correlating the different pre-detections obtained on each Fr. Any other processing enabling identifying targets in a standby mode can be used, such as, and without limitation, a complementary extraction processing, of the “turn by turn” type, to reinforce the control of the false alarm rate upstream of the tracking algorithm.

A target is considered detected when, at the end of this extraction processing (also called ambiguity resolution), the receipt unit 23 concludes that such a target is present in the considered zone.

A target is considered definitively detected when, after multiple implementations of steps 110 and 120, at least K detections are present and correlate in the same zone over a horizon of N implementations of these steps. In this notation, the number K means the number of steps 120 during which the target was considered detected. The coefficient K/N can then be compared with a threshold, called the target extraction threshold.

At the end of this step 120, the receipt unit 23 generates a list of detections, i.e. a list of detected targets.

Then, depending on different embodiments of the invention, the tracking of at least some of the targets can be performed.

It is then understood that the method according to the invention presents a number of advantages.

In particular, the breakdown of the detection mode into at least two sub-modes oriented in different directions enables masking clutter zones, specifically secondary clutter zones, upstream of detection. This enables the detector to detect targets as close as possible to these clutter zones, regardless of the chosen topology, without desensitization (having taken into account clutter samples in the ambient noise power) or false alarms from the primary clutter. This makes the method particularly effective, adaptive to any geometry and combination of surface clutter, and undemanding and predictable in terms of computational capacity.

In some embodiments, the operating method as explained above further comprises the implementation of at least one technique enabling separating the pulse echoes corresponding to different sub-modes, during the emission/receipt of communalized waves, to reconstruct a complete image of the environment. These techniques are usable when the same emission frequency is used for both pulses, for example.

According to a first technique, during the implementation of the n^{th} recurrence of step 110 and specifically during the emission sub-step 112, the emission unit 22 chooses one of the pulses, such as the first pulse, and adds a random phase φᵢₙ to this pulse. Advantageously, the emission unit 22 adds a different random phase φᵢₙ to each of the pulses. The or each pulse having a random phase φᵢₙ added is hereafter called a de-phased pulse.

It should be noted that the choice of the pulse to de-phase can remain the same for each recurrence of this sub-step 112. In other words, when only one pulse is de-phased during this sub-step, the same pulse is de-phased in each recurrence of this step. When both pulses are de-phased during this sub-step, these pulses are also de-phased in each recurrence of this sub-step.

Then, during the receipt sub-step 113, the receipt unit 23 compensates for the dephasing of the received echoes in the frequency band of the or each de-phased pulse, by the corresponding random phase. In other words, the dephasing is performed by subtracting the value din in the band corresponding to the index i.

Thus, during the subsequent processing, only the echoes corresponding to the corresponding sub-mode can be processed coherently. The dephasing of other echoes cannot be done correctly so that they are considered as white noise. This technique also requires processing the distance ambiguity ranks in parallel and having a sufficient number of recurrences to ensure the necessary isolation.

Other techniques for obtaining better isolation of echoes corresponding to different sub-modes during their receipt are also possible. The techniques explained below specifically enable performing a single Doppler processing, contrary to the random phase technique previously mentioned.

Thus, according to a second technique, during the implementation of the n^{th} recurrence of step 110 and specifically during the emission sub-step 112, the emission unit 22 implements different slopes of the chirps used to emit the pulses associated with different sub-modes. In other words, during this sub-step 112, the emission unit 22 emits the pulses using either an ascending slope or a descending slope, depending on the sub-mode associated with each pulse. The same slope is then used for all pulses of this type in all recurrences of step 110.

For example, for all recurrences, an ascending slope is chosen for the pulses associated with a particular sub-mode, and a descending slope is chosen for the pulses associated with another particular sub-mode.

Then, during the receipt sub-step 113, the receipt unit 23 receives echoes having different frequency slopes. This receipt unit 23 therefore determines the received slopes (specifically using matched filters) so as to isolate the echoes corresponding to the different sub-modes.

According to a third technique also enabling better isolation of echoes corresponding to different sub-modes during their receipt, during the implementation of the n^{th} recurrence of step 110 and specifically during the emission sub-step 112, the emission unit 22 implements different polarizations of the waves used to emit the pulses associated with different sub-modes. In other words, during this sub-step 112, the emission unit 22 emits the wave carrying each pulse with a polarization chosen according to the sub-mode associated with this pulse. This same polarization is chosen for this type of pulse for all recurrences of step 110.

For example, two polarizations, namely a vertical polarization and a horizontal polarization, can be chosen for the pulses emitted during sub-step 112. According to other examples, a 45° or circular polarization can be used.

Then, during the receipt sub-step 113, the receipt unit 23 receives echoes having different polarizations. This receipt unit 23 therefore determines the polarizations of the received echoes (specifically using matched filters) so as to isolate the echoes corresponding to the different sub-modes.

The principle just described can be refined by using multiple polarizations in the same pulse.

In such a case, each pulse includes a specific polarization signature. Such a signature corresponds to a polarization code.

This technique thus enables coloring the different pulses in space and obtaining an additional rejection of 20 to 30 dB.

In some embodiments, the aforementioned techniques are combined with each other to be implemented simultaneously. Moreover, the extraction processing, as explained previously, to resolve distance and velocity ambiguities and/or according to at least one pointing direction can also be used in combination with the second technique or the third technique, as described above.

1. An operating method of a target detection radar following a Doppler mode, the method comprising the implementation of multiple recurrences of a signal emission/receipt step, with each n^{th} recurrence of said step comprising the following sub-steps:
generation of two consecutive pulses associated with a first Doppler sub-mode and a second Doppler sub-mode, said Doppler sub-modes defining different energy balances;
emission of pulses in different frequency bands according to different emission directions;
receipt of pulse echoes in a common time window;
preprocessing of received echoes in relation to the first Doppler sub-mode to determine at least one clutter zone;
preprocessing of received echoes in relation to the second Doppler sub-mode outside the or each clutter zone determined in relation to the first Doppler sub-mode;
the method further comprising the following step:
implementation of an extraction processing from a preprocessing result of received echoes in relation to the second Doppler sub-mode.

2. The method according to claim 1, wherein the second Doppler sub-mode defines a greater energy balance than the first Doppler sub-mode.

3. The method according to claim 2, wherein the pulse associated with the second Doppler sub-mode has a greater width than the pulse associated with the first Doppler sub-mode.

4. The method according to claim 1, wherein:
the detection radar is embedded in an aircraft;
the emission direction of the pulse associated with the first Doppler sub-mode corresponds to the ground/sea direction.

5. The method according to claim 1, wherein the preprocessing step of received echoes in relation to the first Doppler sub-mode comprises the determination of at least one primary clutter zone and/or at least one secondary clutter zone.

6. The method according to claim 1, wherein each of the preprocessing sub-steps (114, 115) of received echoes comprises the determination of a power map of echoes, defining a distance axis and a velocity axis.

7. The method according to claim 6, wherein the or each clutter zone is determined by thresholding the power map determined in relation to the first Doppler sub-mode.

8. The method according to claim 6, wherein the or each clutter zone determined in relation to the first Doppler sub-mode is transferred in the form of a mask on the power map determined in relation to the second Doppler sub-mode.

9. The method according to claim 8, wherein the mask is determined by a constant noise value.

10. The method according to claim 8, wherein the preprocessing step of echoes in relation to the second Doppler sub-mode defines a first detection path and a second detection path, the first detection path being implemented from an unmasked power map and the second detection path being implemented from a masked power map;
said preprocessing step further comprising a fusion of detections coming from the two detection paths.

11. The method according to claim 1, wherein:
during the emission sub-step, the corresponding pulses are emitted using different chirp slopes used to emit them or by adding a random phase;
during the receipt sub-step, echoes associated with different pulses are distinguished by determining the slopes of the corresponding chirps or the corresponding phase.

12. The method according to claim 1, wherein:
during the emission sub-step, the corresponding pulses are emitted using different polarizations;
during the receipt sub-step, echoes associated with different pulses are distinguished by determining their polarizations.

13. The method according to claim 12, wherein a polarization is emitted for each pulse or a set of polarizations forming a signature is emitted for each pulse.

14. A detection radar comprising technical modules configured to implement the method according to claim 1.
